(19) United States
(12) Patent Application Publication
(10) Pub. No.: US 2009/0188481 A1
(43) Pub. Date: Jul. 30, 2009

(54) SQUISH-INDUCED MIXING-INTENSIFIED LOW EMISSIONS COMBUSTION PISTON FOR INTERNAL COMBUSTION ENGINES

(75) Inventors: Guangsheng Zhu, Windsor (CA); Houshun Zhang, Canton, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Detroit Diesel Corporation, Detroit, MI (US)

(21) Appl. No.: 12/021,320

(22) Filed: Jan. 29, 2008

(51) Int. Cl. F02B 23/00

(52) U.S. Cl. 123/661

(57) ABSTRACT

A low geometric squish ratio piston for internal combustion engines to facilitate squish inducing mixing and intensified turbulence near engine top dead center The piston comprises a piston head having a height and a width and a depth with a top surface, and a skirt region with a ring region to define a body. The top surface defines an outer radius and is equipped with a combustion bowl recessed in the top surface and concentric therein to define an inner radius. The outer radius and the inner radius define a low geometric squish ratio. The combustion bowl has a deep piston center depth and a relatively high re-entrant angle at a periphery of the combustion bowl radius.

### TECHNICAL FIELD OF THE INVENTION

In one aspect the present invention relates to an improved piston for use in internal combustion engines, and particularly in diesel or Otto Cycle compression combustion engines, that presents low geometric squish ratio and high flow turbulence in the piston combustion chamber to facilitate more efficient combustion of injected fuel and reduce particulate matter and NOx formation during the combustion process by eliminating hot spots and facilitating a more even combustion of fuel in a combustion chamber during operation of the engine.

These and other aspects of the invention will become apparent upon a reading of the specification and claims and a review of the drawings.

### SUMMARY OF THE INVENTION

In one aspect, the present invention relates to a low geometric squish ratio piston for internal combustion engines to facilitate squish inducing mixing and intensified turbulence near engine top dead center. The piston is comprised of a piston head having a height and a width and a depth with a top surface and a skirt region with a ring region to define a body. The top surface defines an outer radius and is equipped with a combustion bowl recessed in the top surface and concentric therein to define an inner radius. The outer radius and the inner radius define a low geometric squish ratio. The combustion bowl has a deep piston center depth and a relatively high re-entrant angle at the periphery of the combustion bowl radius. The low geometric squish ratio of the piston is about 20-40% and the combustion bowl has a re-entrant angle which is about 30-70°.

The combustion bowl inner radius descends substantially parallel to a central axis of the piston from the top surface of the piston at a radiused surface for a defined depth, and then descends from the radiused surface at a re-entrant angle of about 30-70° to a depth sufficient to facilitate turbulence of injected fuel near top dead center. The combustion bowl has a radiused floor portion that ascends from the piston depth at an angle to form a radiused piston center concentric with the piston axis that is lower than the piston top surface.

### BRIEF DESCRIPTION OF THE DRAWINGS

FIG. 1 is a perspective side view of the low geometric squish ratio piston of the present invention showing the top surface, combustion bowl and skirt region and ring region of one embodiment of the low geometric squish ratio piston of the present invention

FIG. 2 is a cut away side view plan of the low geometric squish ratio piston of FIG. 1 showing the contour of the combustion bowl and the ratio of the piston radius with the combustion bowl radius.

FIG. 3 is a graphic representation of a time history of in cylinder turbulence intensity of a conventional combustion bowl and the low geometric squish ratio induced turbulence in a combustion bowl according to one aspect of the present invention.

FIGS. 4A through 4C are a graphic comparison of NOx-Soot results between a conventional piston and a piston according to one aspect of the present invention for three different load levels for a light duty high speed diesel engine.

FIGS. 5A through 5C are a graphic comparison of in cylinder mass averaged NOx, soot and temperature with a conventional piston and a piston according to one aspect of the present invention in a light duty high speed diesel engine.

FIGS. 6A through 6C are a graphic comparison of NOx-soot results between a conventional piston and a piston according to one aspect of the present invention for three different operating conditions for heavy duty Class 8 diesel engine.

### DETAILED DESCRIPTION OF THE PREFERRED EMBODIMENT(S)

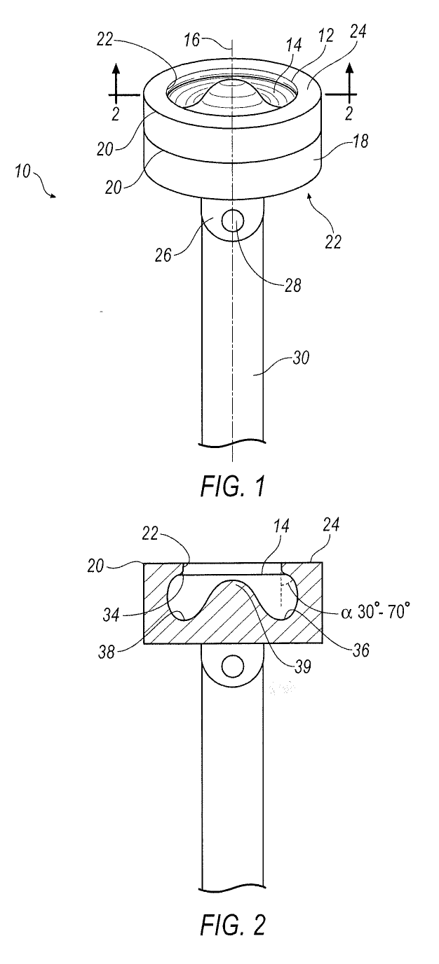

Turning now to the drawings where like numeral refer to like structures, and particularly to FIG. 1, there is depicted therein a perspective side view of the low geometric squish ratio piston 10 of the present invention showing the top surface 12, combustion bowl 14 concentric with a central axis 16 of the piston, and skirt region 18 and ring region 20 to form a piston body 22 having a length and a width according to one embodiment of the low geometric squish ratio piston of the present invention. The outer radius 20 of the piston is separated from the inner radius 22 defined by the combustion bowl, by a relatively large squish area 24. The squish ratio of the piston design according to the present invention is defined as the ratio between the inner radius 22 and the outer radius 20. Accordingly, in may be understood that the smaller the squish ratio, the larger the squish area. The piston has a dog tail 26 that accommodates a pin 28 to pivotally secure the piston to the piston rod 30 in the conventional manner for reciprocation within a cylinder bore in an internal combustion engine, such as, for example, an Otto Cycle or Rankin Cycle compression combustion engine.

Turning to FIG. 2, there is represented a cutaway side view of the piston of FIG. 1, showing the profile of the combustion bowl in the piston. Specifically, the combustion bowl 14 is recessed in said top surface and concentric therein to define the inner radius 32. The ratio of the inner radius 22 and the outer radius 20 define a low geometric squish ratio. The squish area 24 is relatively large, and is defined as the area of the piston top surface between the outer radius and the inner radius. In the embodiment as shown, it is contemplated that the squish ratio is about 20-40%, which is relatively low when compared to conventional pistons that have a squish ration of about 50% or larger. The combustion bowl has a deep piston depth running circumferentially around the combustion bowl and a relatively high re-entrant angle α of about 30-70° at the periphery of the combustion bowl radius. Specifically, the combustion bowl inner radius descends substantially parallel to the central axis of the piston from the top surface of the piston at a radiused surface 34 for a defined depth 38, and then descends from the radiused surface at a re-entrant angle of about 30-70° to a depth sufficient to facilitate turbulence of injected fuel near top dead center. The combustion bowl has a radiused floor portion 36 that extends circumferentially around the combustion bowl and ascends from the depth at an angle to form a radiused piston center 38 concentric with the piston axis. In is understood that the radiused piston center is lower than the piston top surface. These features ensure a greatly increased turbulence level that significantly enhances air-fuel mixing which, in turn, reduces emissions significantly.

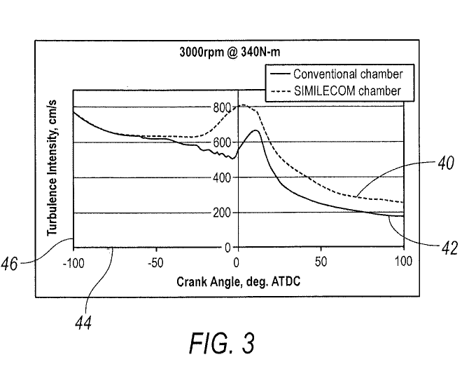

Turning to FIG. 3, there is represented a time history of engine in cylinder mass averaged turbulence intensity for an engine with conventional combustion chambers 40 and one with the advanced combustion characteristics 42 according to the present invention. The engine used was a 4.0 liter light duty high speed diesel engine operated at about 3000 rpm and for the conventional combustion chamber, the geometric squish ratio was 52%. For the combustion chamber as defined according to the present invention, the geometrical squish ratio was 32%. The X axis 44 is crank angle, degree after TDC, and the Y axis 46 is Turbulence intensity in cm/s. As can be clearly seen in FIG. 3 the turbulence intensity with the conventional chamber decreases with the engine piston approaching Top Dead Center (TDC) which is a character typically featured with conventional chamber design. However, with the use of a piston according to the present invention, as the piston moves up to TDC, the turbulence is greatly improved by the combustion bowl configuration, resulting in higher turbulence levels in a period during which fuel injection and combustion happen. Typically, this occurs between 15 crank angle degrees before TDC and 40 angle crank degrees after TDC. As a result, the fuel air mixing and combustion processes are significantly enhanced and the engine emissions are greatly reduced.

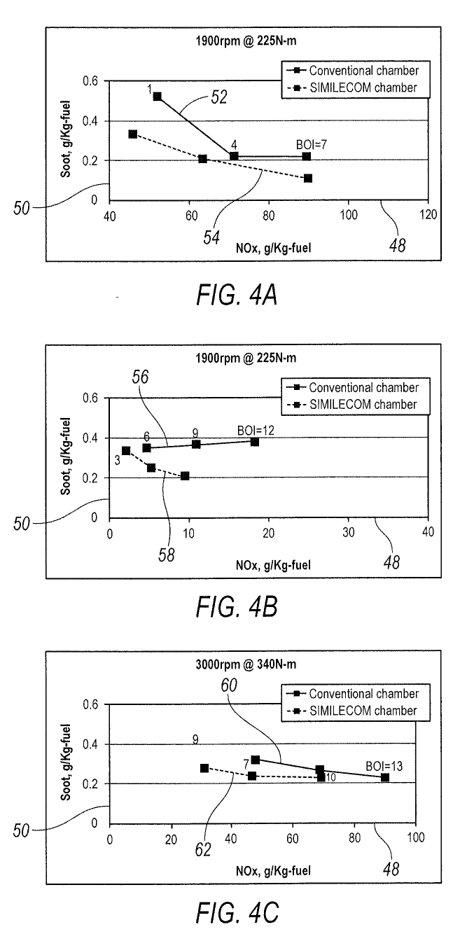

FIGS. 4A through 4C are comparisons for NOx-soot results observed between conventional combustion cylinders and cylinders configured according to at least one embodiment according to the present invention. Each of the figures represents the same light duty diesel engine operated at different loads and the resulting NOx emissions for both the conventional piston and the piston according to the at least one aspect of the present invention. In each figure, the X axis 48 is NOx g/Kg-fuel consumed, and the Y axis 50 is Soot, g/Kg fuel consumed.

FIG. 4A is the results of a 4.0 liter light duty diesel engines operated at about 1900 rpm at 225 N-m engine torque. The conventional chamber piston results may be seen at 52, and the improved combustion chamber piston according to the present invention may be seen at 54. It can be seen that the combustion chamber according to the present invention results in reduced NOx and soot at low speed.

FIG. 4B is the results of a 4.0 liter light duty diesel engine operated at about 3200 rpm at 53 N-m engine torque. Again, the conventional piston NOx and soot production at 56 are higher than the NOx and soot product for the combustion piston according to the present invention at 58.

Similarly, FIG. 4C shows the results of a 4.0 liter light duty diesel engine operated at about 3000 rpm at 340 N-nm engine torque. As indicated in the previous FIGS. 4A and 4B, the NOx and soot production of the conventional piston 60 are higher than the NOx and soot production 62 by the pistons according to the present invention.

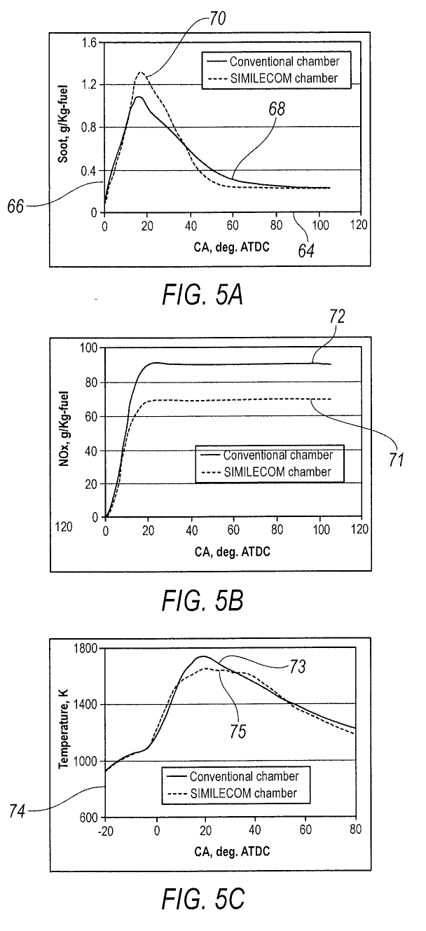

Other aspects can be seen by resort to FIGS. 5A through C. In each of FIGS. 5A through 5C, the X axis 64 is Crank Angle Degree After Top Dead Center. The engine is a 4.0 liter light duty high speed diesel engine operated at about 3000 rpm at 340N-m engine torque and a BOI of 13 crank degrees before TDC.

In FIG. 5A, the Y axis 66 is soot in g/Kg fuel. The conventional piston 68 and the piston according to the present invention 70 performed at about the same rate with the conventional piston producing lower soot at crank angles before about 40, and thereafter the piston according to the present invention produced less soot per kilogram of fuel consumed.

FIG. 5B shows the comparison between the piston of the present invention 71 and a conventional piston in the production of NOx g/Kg fuel as set forth at 72. It can be seen that over substantially the larger part of the engine operation range, the conventional piston produced more NOx than the piston according to the present invention.

FIG. 5C, the Y axis 74 is the temperature of the combustion in Kelvin. The temperature of combustion of the conventional piston and the piston according to the present invention are about the same over the greater portion of their operation. However, at about 20 crank angle before TDC, the temperature of combustion in the piston of the present invention is lower than the temperature of combustion in the conventional piston. The conventional piston 73 creates a higher combustion temperature than the piston according to the present invention as seen at 75.

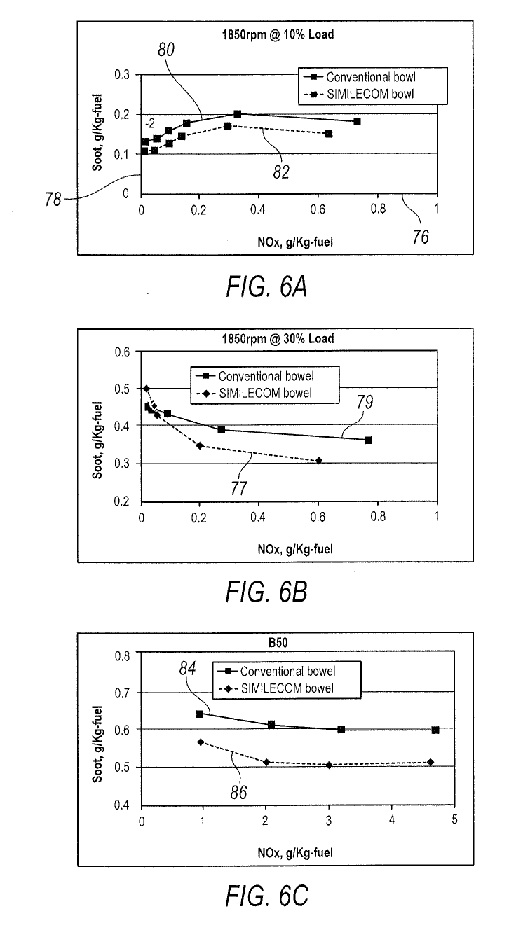

FIGS. 6A through 6C depict the operational results of running conventional pistons and the piston according to the present invention in a Detroit Diesel 14.0 liter, heavy duty class 8 diesel engine at various speeds and loads. In each of FIGS. 6 A through C, the X axis 76 is NOx g/kg-fuel consumed and Y axis 78 is Soot g/Kg fuel consumed. In FIG. 6A, the engine was operated at 1850 rpm at 10% load. The conventional piston 80 produced more soot and NOx per kilogram of fuel consumed than the piston according to the present invention 82.

In FIG. 6B, the engine was run at 1850 rpm at 30% load. Initially, the piston according to the present invention 77 produced slightly more soot than the conventional piston 79. Thereafter, the piston according to the present invention produced significantly less soot than the conventional piston. In addition, the convention piston produced more NOx per kilogram of fuel consumed than the piston of the present invention.

In FIG. 6C the engine was operated at 1520 rpm at 50% load. In every instance, the conventional piston 84 produced significantly more soot than the piston according to the present invention, as seen at 86.

The words used in the description of the present invention are words of description and not words of limitation. Those skilled in the art will recognize that many variations are possible without departing form the scope and spirit of the invention as set forth in the appended claims.

1. A low geometric squish ratio piston for internal combustion engines to facilitate squish inducing mixing and intensified turbulence near engine top dead center, comprising: a piston head having a height and a width and a depth with a top surface, and a skirt region with a ring region to define a body, said top surface defining an outer radius and equipped with a single combustion bowl recessed in said top surface and concentric therein to define an inner radius, said outer radius and said inner radius defining a low geometric squish induced ratio of about 20-40%; said combustion bowl having a deep piston center depth and a relatively high re-entrant angle at a periphery of said combustion bowl radius and enhanced turbulance between 15 crank angle degrees before drop dead center and 40 crank angle degrees after top dead center.

2. The low geometric squish ratio piston of claim 1, wherein said low geometric squish induced ratio is about 20-40%.

3. The low geometric squish ratio piston of claim 1, wherein said re-entrant angle is about 30-70°.

4. The low geometric squish ratio piston of claim 1, wherein said combustion bowl inner radius descends substantially parallel to a central axis of said piston from said top surface of said piston at a radiused surface for a defined depth, and then descends from said radiused surface at a re-entrant angle of about 30°-70° to a depth sufficient to facilitate turbulence of injected fuel near top dead center, said combustion bowl having a radiused floor portion that ascends from said depth at an angle to form a radiused piston center concentric with said piston axis, said radiused piston center lower than said piston top surface.
